(19) United States
(12) Patent Application Publication
(10) Pub. No.: US 2017/0323165 A1
(43) Pub. Date: Nov. 9, 2017

(54) CAPTURING APPARATUS FOR RECOGNIZING A GESTURE AND/OR A VIEWING DIRECTION OF AN OCCUPANT OF A MOTOR VEHICLE BY SYNCHRONOUS ACTUATION OF LIGHTING UNITS, OPERATING ARRANGEMENT, MOTOR VEHICLE AND METHOD

(71) Applicant: VALEO Schalter und Sensoren GmbH, Bietigheim-Bissingen (DE)

(72) Inventor: Thomas Haebig, Bietigheim-Bissingen (DE)

(73) Assignee: VALEO Schalter und Sensoren GmbH, Bietigheim-Bissingen (DE)

(21) Appl. No.: 15/535,177

(22) PCT Filed: Dec. 4, 2015
(86) PCT No.: PCT/EP2015/078623

§ 371 Date: Jun. 12, 2017

(30) Foreign Application Priority Data
Dec. 11, 2014 (DE) 10 2014 118 387.8

(51) Int. Cl. G06K 9/00; G06K 9/20; B60R 1/00; G06F 3/0482; G06F 3/01

(52) U.S. Cl. CPC G06K 9/00845; G06K 9/00375; G06K 9/00604; G06K 9/2027; G06K 9/209; G06K 9/00355; B60R 1/00; B60R 2300/105; B60R 2300/30; G06F 3/013; G06F 3/017; G06F 3/0482

(57) ABSTRACT

The invention relates to a capturing apparatus (3) for recognizing a gesture and/or a viewing direction of an occupant (13) of a motor vehicle (1), comprising a first sensor device (5) and comprising at least one second sensor device (6), wherein each of the sensor devices (5, 6) respectively has a lighting unit (7) for emitting light (11), a receiving unit (8) for receiving the light (12) reflected by the occupant (13) and a computer unit (9) for actuating the lighting unit (7) and for recognizing the gesture and/or the viewing direction on the basis of the reflected light (12), wherein the computer units (9) of the sensor devices (5, 6) are designed to actuate the lighting units (7) synchronously as a function of a synchronization signal.

The present invention relates to a capturing apparatus for recognizing a gesture and/or a viewing direction of an occupant of a motor vehicle, comprising a first sensor device and comprising at least one second sensor device, wherein each of the sensor devices respectively has a lighting unit for emitting light, a receiving unit for receiving the light reflected by the occupant and a computer unit for actuating the lighting unit and for recognizing the gesture and/or the viewing direction on the basis of the reflected light. The invention moreover relates to an operating arrangement and a motor vehicle. Finally, the present invention relates to a method for recognizing a gesture and/or a viewing direction of an occupant of a motor vehicle.

A multiplicity of capturing apparatuses, by means of which e.g. an operating action of a vehicle occupant can be recognized, are installed in modern motor vehicles. By way of example, the detection of a gesture of a vehicle occupant using such a capturing apparatus is known. In this case, the capturing apparatus comprises e.g. a sensor device in the form of a camera, by means of which the operating gesture of the occupant can be captured and evaluated by means of a corresponding computer unit. Then, an operating signal may be produced as a function of the captured gesture, said operating signal being able to be used to actuate a functional device of the motor vehicle.

Furthermore, the prior art has disclosed capturing apparatuses, by means of which a viewing direction of the driver can be captured. Hence, it is possible, for example, to recognize whether a driver directs his vision onto the roadway. Moreover, on the basis of the viewing direction of the driver, it is possible, for example, to identify the functional device of the motor vehicle which is viewed by the driver.

Such capturing apparatuses for recognizing a gesture and/or the viewing direction of a vehicle occupant usually have an optical sensor with an active lighting unit. In particular, the capturing apparatuses are embodied as cameras, with the lighting units emitting light in the visible wavelength range or in the infrared wavelength range. Using a camera, it is possible, for example, to record an image of part of the occupant, for example the hand. Moreover, so-called 3D cameras are known, by means of which it is possible to provide a pictorial representation of distances. In this context, e.g. so-called TOF (TOF time-of-flight) cameras are known, which emit light with the lighting unit and which capture the light reflected by the occupant by means of a receiving unit. Then, it is possible to deduce the distance between the capturing apparatus and at least part of the occupant on the basis of the time-of-flight of the light.

To this end, DE 10 2008 048 325 A1 describes an actuation input unit comprising an image recording device. Moreover, the actuation input unit comprises a hand region detection device which detects a region of a human hand in a movement image recorded by the image recording device. Moreover, provision is made of a hand actuation determination apparatus which determines a hand actuation from a form and movement of the detected hand region. Finally, a menu selection representation device is provided which notifies a user about a selected menu on the basis of the determined actuation. Here, provision may also be made for the actuation input machine to comprise a multiplicity of image recording apparatuses.

Moreover, DE 10 2012 110 460 A1 describes a method for entering a control command for a component of a motor vehicle. Here, an image sequence of an input object guided by a user is produced in a predetermined capturing region by means of an imaging device. Furthermore, a change in orientation of the input object is identified on the basis of the image sequence and a control command is output to a component of the motor vehicle on the basis of the recognized change in orientation. Here, the imaging device may comprise at least one infrared-sensitive camera.

Moreover, WO 2014/032822 A2 describes an apparatus for controlling vehicle functions. The apparatus comprises at least one interface, with which a user interacts by way of static and/or dynamic user gestures. Moreover, provision is made of a detection unit which captures the static and dynamic user gestures. Moreover, a user gesture is captured by means of a control unit and a corresponding vehicle function is actuated. Here, the detection unit may comprise one or more cameras which, in particular, are embodied as TOF cameras. Using these, it is preferably possible to identify the movement of a part of the head, in particular of the eye or the nose. Moreover, the detection unit is configured to recognize parallel gestures of a user and/or the gestures of a plurality of people at the same time and/or in sequential fashion.

It is an object of the present invention to provide a solution for how a capturing apparatus of the type set forth at the outset may be operated more reliably for the purposes of capturing a gesture and/or a viewing direction of an occupant of a motor vehicle.

This object is achieved by a capturing apparatus, by an operating arrangement, by a motor vehicle and by a method having the features in accordance with the respective independent patent claims. Advantageous embodiments of the invention are the subject matter of the dependent patent claims, the description and the figures.

A capturing apparatus according to the invention serves to recognize a gesture and/or a viewing direction of an occupant of a motor vehicle. The capturing apparatus comprises a first sensor device and at least one second sensor device. Each of the sensor devices respectively has a lighting unit for emitting light. Moreover, each of the sensor devices comprises a receiving unit for receiving the light reflected by the occupant. Further, each of the sensor devices comprises a computer unit for actuating the lighting unit and for recognizing the gesture and/or the viewing direction on the basis of the reflected light. Here, the computer units of the sensor devices are designed to actuate the lighting units synchronously as a function of a synchronization signal.

The capturing apparatus may be used in a motor vehicle. Using the capturing apparatus, it is possible to capture a gesture of an occupant of the motor vehicle and/or a viewing direction of the occupant of the motor vehicle. The capturing apparatus comprises at least two sensor devices which, for example, may be arranged distributed in the interior of the motor vehicle. The sensor devices can comprise an optical sensor or a camera. Each of the sensor devices comprises a lighting unit. This lighting unit can be actuated by means of the computer unit. Hence, it is possible to control a lighting time, i.e. the time duration during which the light is emitted by the respective lighting unit. Thus, the sensor devices have an active illumination. The light emitted by the respective lighting unit impinges on a part, for example a body part, of the occupant and is reflected by the latter and, in turn, reaches the receiving unit of the respective sensor device. Depending on the reflected light, the computer unit can then identify the gesture and/or the viewing direction of the occupant.

The present invention is based on the discovery that if use is made of at least two sensor devices with an active illumination, there may be influences of the sensor devices among themselves. By way of example, interferences may occur as a consequence of the respective light emitted by the lighting units. In the present case, the computer units of the respective sensor devices are able to synchronously actuate their lighting units as a function of a synchronization signal. By way of example, the lighting units of the at least two sensor devices may therefore be actuated in a specific sequence at the same time.

As a result of the synchronous operation of the respective lighting units of the sensor devices, it is possible to avoid mutual interferences of the sensor devices by way of their lighting units. Further, this can moreover facilitate an ideal illumination of the respective detection region of the sensor devices.

Preferably, the computer unit of the first sensor device is designed to provide the synchronization signal and transfer the latter to the computer unit of the second sensor device. Hence, the computer unit of the first sensor device serves as a master and the computer unit of the second sensor device serves as a slave. The computer unit of the first sensor device provides a corresponding synchronization signal. Depending on this synchronization signal of the computer unit of the first sensor device, it is possible to actuate the lighting unit of the first sensor device. Moreover, this synchronization signal may comprise information relating to when the lighting unit of the second sensor device should be actuated. This synchronization signal is then transferred from the computer unit of the first sensor device. A time delay arising during the transfer from the computer unit of the first sensor device to the computer unit of the second sensor device may also be taken into account in the synchronization signal. Hence, the synchronization signal can be provided using a computer unit of one of the sensor devices themselves.

Moreover, it is advantageous if the computer units of the first sensor device and the at least one second sensor device are linked via a data line for transferring the synchronization signal. By way of the data line, it is possible, for example, to provide a direct data link between the computer units of the two sensor devices. Hence, it is possible to guarantee a reliable transfer of the synchronization signal between the sensor devices. Moreover, a time delay during the transfer of the synchronization signal can be prevented or reduced by way of the direct link.

Preferably, the data line is a data bus of the motor vehicle, in particular a CAN bus. Hence, the transfer of the synchronization signal may be brought about by way of the already existing data bus of the motor vehicle. By way of the transfer of the synchronization signal, as a function of which the respective lighting units of each of the sensor devices are actuated, it is possible to reliably avoid a disturbance of the sensor devices among themselves. What is taken into account here is that the time duration for processing a data frame, which is transferred via a data bus, is significantly longer than the lighting duration during which a lighting unit is activated. Hence, a reliable operation of the capturing apparatus may be facilitated.

In a further embodiment, the first sensor device and/or the at least one second sensor device is designed to determine a distance to at least a part of the occupant on the basis of a time-of-flight of the emitted light and of the reflected light. Expressed differently, the first sensor device and/or the second sensor device is embodied as a so-called 3D camera or TOF camera. Hence, it is possible to spatially capture a part of the occupant, for example a hand of the occupant. In this way, it is possible to recognize corresponding gestures of the vehicle occupant and evaluate these by means of the computer unit. In the process, there may be e.g. a comparison with predetermined gestures which, for example, are stored in the computer unit. Depending on the captured gesture, it is then possible to transfer a corresponding operating signal to a functional device of the motor vehicle.

In a further embodiment, the first sensor device and/or the at least one second sensor device is configured to capture an image of at least a part of the occupant on the basis of the reflected light. Expressed differently, the first sensor device and/or the at least one second sensor device is embodied as a camera, by means of which it is possible to capture an image of the body part of the occupant. In particular, the first sensor device and/or a second sensor device is designed to recognize a viewing direction of the occupant on the basis of the captured image. Hence, it is possible to recognize whether, for example, the driver or the occupant directs their view onto the roadway. Furthermore, it is moreover possible to identify whether, for example, the driver has their eyes opened or closed. Provision may also be made for identification of which functional device of the motor vehicle is intended to be operated by the occupant on the basis of the viewing direction. A corresponding operating signal may be output on the basis of the captured viewing direction.

Furthermore, it is advantageous if the computer unit of the first sensor device and the computer unit of the at least one second sensor device alternately actuate the lighting units when capturing the gesture with the first sensor device and the at least one second sensor device. Expressed differently, the two sensor devices are operated alternately for the purposes of capturing the gesture. In this way, it is possible to prevent mutual influencing of the sensor devices when capturing the gesture.

In a further configuration, the computer unit of the first sensor device and the computer unit of the at least one second sensor device will simultaneously actuate the lighting units when capturing the viewing direction by means of the first sensor device and the at least one second sensor device. If the viewing direction of the occupant should be identified, the synchronization of the lighting units can be effected in such a way that both lighting units are active at the same time. In this way, it is possible to facilitate an ideal illumination of the detection regions of the respective sensor devices. Hence, it is possible to reliably capture the viewing direction of the occupant.

An operating arrangement according to the invention for a motor vehicle comprises a capturing apparatus according to the invention. Moreover, the operating arrangement comprises a functional device which is actuatable as a function of the gesture and/or viewing direction recognized by the capturing apparatus. If a gesture and/or a viewing direction of the occupant is recognized with the capturing apparatus, it is possible to output an appropriate operating signal and transfer the latter to the functional device. The functional device may then be actuated as a function of this operating signal. By way of example, the functional device of the motor vehicle may be an infotainment system, a navigation system or the like. Provision may also be made for the functional device to be a window lift, an actuator for adjusting the external mirrors or the like. The operating arrangement may also be part of a driver assistance system of the motor vehicle which, for example, carries out an intervention in the steering and/or the braking system. This is particularly advantageous if the capturing apparatus identifies that the driver's view is turned away from the roadway and danger threatens.

A motor vehicle according to the invention comprises an operating arrangement according to the invention. In particular, the motor vehicle is embodied as a passenger motor vehicle.

A method according to the invention serves to recognize a gesture and/or a viewing direction of an occupant of a motor vehicle. Here, a first sensor device and at least one second sensor device are provided. Here, in each one of the sensor devices, a lighting unit for emitting light is actuated by means of a computer unit, the light reflected by the occupant is received by means of a receiving unit and the gesture and/or the viewing direction is recognized by means of the computer unit on the basis of the reflected light. The lighting units are actuated synchronously by means of the computer units of the sensor devices, as a function of a synchronization signal.

Preferred embodiments presented with respect to the capturing apparatus according to the invention and the advantages thereof apply accordingly to the operating arrangement according to the invention, the motor vehicle according to the invention and the method according to the invention.

Further features and inventions emerge from the claims, the figures and the description of the figures. The features and feature combinations mentioned in the description above and the features and feature combinations mentioned in the description of the figures below and/or only shown in the figures may be used not only in the respectively specified combination, but also in other combinations or on their own, without departing from the scope of the invention. Hence, embodiments which are not explicitly shown and explained in the figures but which emerge from the explained embodiments by way of separate feature combinations and which are producible should therefore also be considered to be comprised and disclosed by the invention. Embodiments in feature combinations which therefore do not have all features of an originally phrased independent claim should also be considered to be disclosed.

The invention is now explained in more detail on the basis of preferred exemplary embodiments and with reference to the attached drawings.

In the figures:

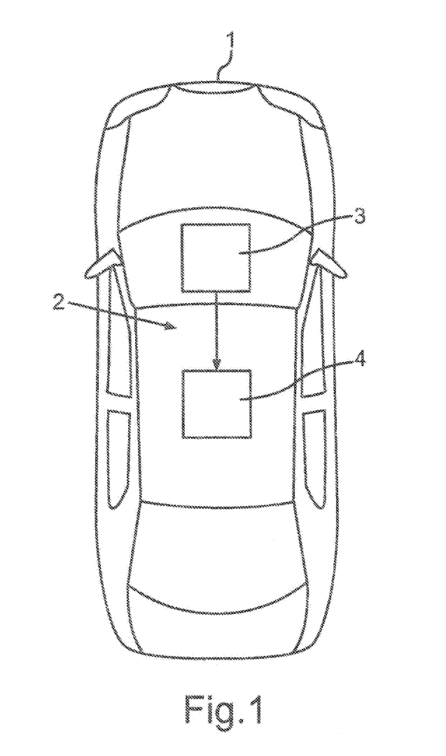

FIG. 1 shows a schematic illustration of a motor vehicle in accordance with one embodiment of the present invention;

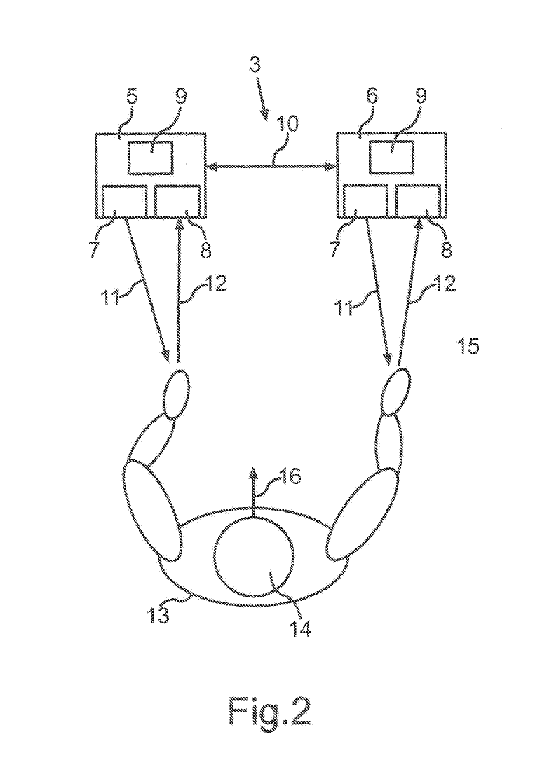

FIG. 2 shows a capturing apparatus of the motor vehicle, by means of which a gesture and/or a viewing direction of an occupant is captured; and

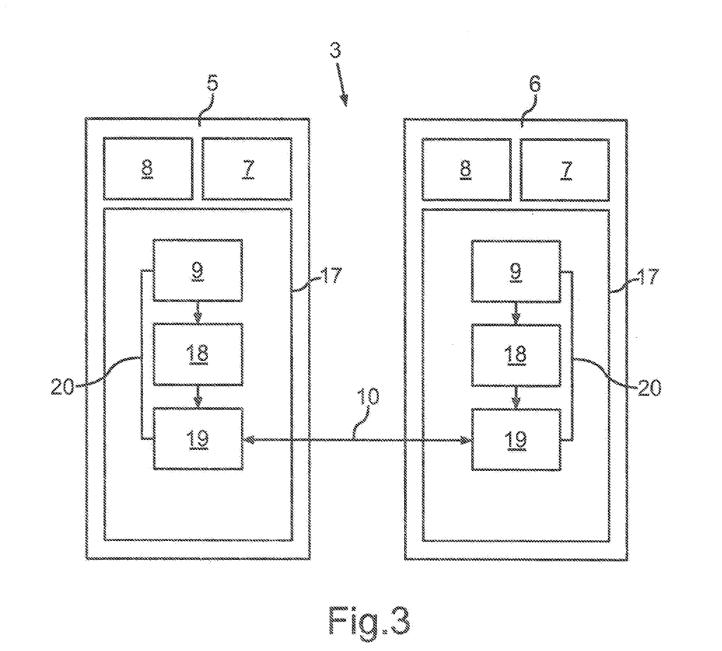

FIG. 3 shows the capturing apparatus in accordance with FIG. 2, which comprises a first sensor device and a second sensor device.

In the figures, equivalent or functionally equivalent elements are provided with the same reference signs.

FIG. 1 shows a schematic illustration of a motor vehicle 1 in accordance with one embodiment of the present invention. In the present case, the motor vehicle 1 is embodied as a passenger motor vehicle. The motor vehicle 1 comprises an operating arrangement 2. The operating arrangement 2 in turn comprises a capturing apparatus 3. Using the capturing apparatus 3, it is possible as explained in more detail below to capture a gesture and/or a viewing direction of an occupant 13 of the motor vehicle 1.

Depending on the captured gesture and/or the captured viewing direction, it is possible to transfer a corresponding operating signal from the capturing apparatus 3 to a functional device 4 of the motor vehicle 1.

By way of example, the functional device 4 of the motor vehicle 1 may be a navigation system, an infotainment system, an air conditioning unit or the like. The functional device 4 may also be an appropriate actuator for opening and/or closing the windows, an actuator for adjusting the external mirrors, an actuator for opening and/or closing a sliding roof or a soft top, an actuator for adjusting the seats or the like. The functional device may also be part of a driver assistance system of the motor vehicle 1.

FIG. 2 shows a schematic illustration of an embodiment of the capturing apparatus 3. In the present exemplary embodiment, the capturing apparatus 3 comprises a first sensor device 5 and a second sensor device 6. Provision may also be made for the capturing apparatus 3 to comprise more than two sensor devices 5, 6. The sensor devices 5, 6 may be arranged distributed in the interior of the motor vehicle 1. Each of the sensor devices 5, 6 comprises a lighting unit 7, by means of which it is possible to emit light. By way of example, the lighting unit 7 may be embodied to emit light in the visible wavelength range or light in the infrared wavelength range. The emitted light 11 is reflected by a part of the occupant 13. The reflected light 12 reaches a receiving unit 8 of the respective sensor device 5, 6.

One or both of the sensor devices 5, 6 may be embodied as cameras which, depending on the reflected light 12, may capture an image of at least a part of the occupant 13. One or both of the sensor devices 5, 6 may be embodied as so-called 3D cameras or TOF cameras. Using these, it is possible to recognize the spatial orientation of a part of the occupant 13 on the basis of the reflected light 12. Hence, it is possible, for example, to recognize a gesture carried out by a hand 15 of the occupant 13. Furthermore, it is possible, for example, to identify an orientation, an inclination and/or a rotation of the head 14 of the occupant 13. The sensor devices 5, 6 may also be configured to recognize a viewing direction of the occupant 13, for example on the basis of the position of the eyes of the occupant 13. In the present case, this is depicted in an exemplary manner by arrow 16.

Each of the sensor devices 5, 6 comprises a computer unit 9. By way of example, it may be formed by an appropriate processor, by an integrated circuit or by a so-called FPGA (field programmable gate array). The respective computer units 9 serve to actuate the lighting units 7 of the sensor devices 5, 6. If the respective lighting units 7 are actuated, the latter emit the light 11. Moreover, the computer units 9 are designed to recognize the gesture or the viewing direction of the occupant 13 on the basis of the reflected light 12. To this end, it is possible, for example, to carry out appropriate image processing, on the basis of which gestures and/or viewing direction are identified.

The sensor devices 5, 6 are linked by way of a data line 10 for data transfer. In particular, the computer units 9 of the respective sensor devices 5, 6 are linked by the data line 10. By way of example, the data line 10 may be formed by a data bus of the motor vehicle 1, for example the CAN bus. By way of the data bus, it is possible to transfer a corresponding synchronization signal, as a function of which the respective computer units 9 synchronously actuate the lighting units 7.

FIG. 3 shows the capturing apparatus 3 in a further embodiment. It is possible to recognize here that each of the sensor devices 5, 6 has a corresponding sensor board 17, on which the computer units 9 are arranged. Moreover, provision is made of a corresponding processor 18. Further, each of the sensor devices 5, 6 has a communication interface 19, said communication interfaces being linked to the data line 10. Furthermore, a direct link is provided between the communication interface and the computer unit 9 by way of a data line 20. When the capturing apparatus 3 is started up, it is possible to transfer corresponding data frames via the data line, in particular the CAN bus. Here, it is possible, for example, to define the computer unit 9 of the first sensor device as a master. The computer unit 9 of the second sensor device 6 may be defined as a slave.

Then, a corresponding synchronization signal may be provided by the computer unit 9 of the first sensor device 5. This synchronization signal may be provided by any data frame which is transferred via the data line 10. Depending on the transferred synchronization signal, the computer units 9 are then able to actuate the respective lighting units 7. By way of example, the lighting units 7 may be actuated at the same time or with a temporal offset. As a result of the synchronous operation of the lighting units 7, it is possible, in particular, to avoid influencing of the sensor devices 5, 6 among themselves.

1. A capturing apparatus for recognizing a gesture and/or a viewing direction of an occupant of a motor vehicle, comprising:
a first sensor device;
at least one second sensor device, wherein each of the sensor devices respectively has a lighting unit for emitting light; and
a receiving unit for receiving the light reflected by the occupant and a computer unit for actuating the lighting unit and for recognizing the gesture and/or the viewing direction on the basis of the reflected light, wherein the computer units of the sensor devices are designed to actuate the lighting units synchronously as a function of a synchronization signal.

2. The capturing apparatus according to claim 1, wherein the computer unit of the first sensor device is designed to provide the synchronization signal and transfer the latter to the computer unit of the second sensor device.

3. The capturing apparatus according to claim 1, wherein the computer units of the first sensor device and the at least one second sensor device are linked via a data line for transferring the synchronization signal.

4. The capturing apparatus according to claim 3, wherein the data line is a CAN bus of the motor vehicle.

5. The capturing apparatus RPM according to claim 1, wherein the first sensor device and/or the at least one second sensor device is designed to determine a distance to at least a part of the occupant on the basis of a time-of-flight of the emitted light and of the reflected light.

6. The capturing apparatus according to claim 1, wherein the first sensor device and/or the at least one second sensor device is configured to capture an image of at least a part of the occupant on the basis of the reflected light.

7. The capturing apparatus according to claim 1, wherein the computer unit of the first sensor device and the computer unit of the at least one second sensor device alternately actuate the lighting units when capturing the gesture by means of the first sensor device and the at least one second sensor device.

8. The capturing apparatus according to claim 1, wherein the computer unit of the first sensor device and the computer unit of the at least one second sensor device simultaneously actuate the lighting units when capturing the viewing direction with the first sensor device and the at least one second sensor device.

9. An operating arrangement for a motor vehicle comprising:
a capturing apparatus according to claim 1;
a functional device actuatable as a function of the gesture and/or viewing direction recognized by the capturing apparatus.

10. A motor vehicle comprising an operating arrangement according to claim 9.

11. A method for recognizing a gesture and/or viewing direction of an occupant of a motor vehicle having a first sensor device and at least one second sensor device are provided, the method comprising:
in each one of the sensor devices, actuating a lighting unit for emitting light by a computer unit; and
receiving the light reflected by the occupant by a receiving unit; and
recognizing the gesture and/or the viewing direction by the computer unit on the basis of the reflected light,
wherein the lighting units are actuated synchronously by the computer units of the sensor devices, as a function of a synchronization signal.
